(19) United States
(12) Patent Application Publication
(10) Pub. No.: US 2021/0017093 A1
(43) Pub. Date: Jan. 21, 2021

(54) Ceramic Dots Process

(71) Applicant: Hutchinson Technology Incorporated, Hutchinson, MN (US)

(72) Inventors: Paul V. Pesavento, Hutchinson, MN (US); Peter F. Ladwig, Hutchinson, MN (US); Michael W. Davis, Rockford, MN (US)

(21) Appl. No.: 16/512,178

(22) Filed: Jul. 15, 2019

(51) Int. Cl. C04B 41/51; C04B 41/52; C04B 41/90

(52) U.S. Cl. CPC C04B 41/5144; C04B 41/90; C04B 41/52

(57) ABSTRACT

A method to fuse ceramic to a metallic substrate is provided. The method includes dispensing a ceramic material onto the metallic substrate and firing of the ceramic material to the metallic substrate at a predetermined temperature. The firing of the ceramic material promotes adhesion between the ceramic material and the metallic substrate.

### FIELD

Embodiments of the invention relates generally to an improved process of adhering a ceramic to a different substrate.

### BACKGROUND

The coating of a substrate with another material enables a solid surface or structure to be built up from successive layers of material deposited by either thermal, chemical or mechanical processes. In some cases, coating methods are used to alter the surface or other properties and characteristics of the final product. In other cases, coating methods are used to form an entire structure or product from successive layers of deposited material. A variety of coating methods are used to deposit various coating material precursors. Examples of common coating methods include High Velocity Oxygen Fuel (HVOF), High Velocity Air Fuel (HVAF), plasma spray, laser sintering/cladding, kinetic metallization, electric arc deposition and detonation coating.

In general, the listed common coating processes include injecting coating precursor material or particles into a gas stream for acceleration and, in most cases, heating the particles to their melting point using one of various energy sources (combustion, laser, electric arc, etc.). Upon impact with the substrate, the particles, if molten, splatter onto the surface and solidify, or if still solid, plastically collide with the substrate and embeds in it. Successive bombardment with particles results in a built up coating layer.

While each of these known approaches has a unique set of advantages and disadvantages, they all face similar challenges. The main challenge is to form a strong bond between the base layer (or substrate) and the newly applied layer of material and to deposit coating material with high density and low porosity. Typically, the goal is to have the properties of the coating approach the properties of the same material in full-density bulk form. However, depending on the material system of interest, successful coatings often fall far from these standards. For example, for the cermet WC10Co (tungsten carbide 10% cobalt), HVOF coatings are considered to be excellent when they have porosity <1% and hardness of 1000 HV, while optimal properties in bulk form may approach 0% porosity and 2000 HV hardness. The disparity between the material properties as HVOF coated material and the bulk properties leave much to be desired from coating application standpoint. As a result, there remains a continuing need for enhanced coating processes.

### SUMMARY

A method to fuse ceramic to a metallic substrate is provided. The method includes dispensing a ceramic material onto the metallic substrate and firing of the ceramic material to the metallic substrate at a predetermined temperature. The firing of the ceramic material promotes adhesion between the ceramic material and the metallic substrate.

In some implementations, the metallic substrate is a stainless steel alloy. The peak firing temperature can be between 800C-1100C. In some implementations, the peak firing temperature is 965C. The firing of the ceramic material can be conducted in an inert atmosphere. The inert atmosphere can include Argon. In some implementations, the inert atmosphere can include Nitrogen.

In some implementations, firing of the ceramic material can be conducted in a reducing atmosphere. The reducing atmosphere can include ammonia. The reducing atmosphere can include any active reducing agent that causes a depletion of oxygen. In some implementations, the reducing atmosphere can include forming gas. The reducing atmosphere can include hydrogen. The reducing atmosphere can include a mixture of gases, including hydrogen and one or more noble gases.

In some implementations, the metallic substrate can include SST Substrate (17-7PH). When firing of the ceramic material at a predetermined temperature of 975-degrees Celsius or above simultaneously, the SST Substrate (17-7PH) is hardened while the ceramic material is simultaneously adhered to the SST Substrate (17-7PH).

In some implementations, the ceramic material includes ceramic paste material. Dispensing the ceramic material can include using a jet dispensing process that dispenses the ceramic material in a uniform array of ceramic dots. The jet dispensing process enables customization of size and height of each of the ceramic dots.

In some implementations, dispensing the ceramic material includes using a time and pressure needle dispensing process that dispenses the ceramic material in a uniform array of ceramic dots. The time and pressure needle dispensing process can provide a metered amount of material dispensed by controlling time and pressure. The time and pressure needle dispensing process includes positioning a needle over each ceramic dot for a prescribed time period to allow for a consistent tail break.

Other features and advantages of implementations of the present invention will be apparent from the accompanying drawings and from the detailed description that follows.

### BRIEF DESCRIPTION OF THE DRAWINGS

Implementations of the present invention are illustrated, by way of example and not limitation, in the figures of the accompanying drawings, in which like references indicate similar elements and in which:

FIG. 1 illustrates a cross-sectional view of a substrate of metal (e.g., stainless steel) for forming ceramic dots thereon according to an implementation; and

FIG. 2 illustrates an exemplary ceramic dot adhered to the stainless steel substrate, according to an implementation.

### DETAILED DESCRIPTION

A preferred method for fusing a glass coating deposited on a metal (e.g., stainless steel) surface is provided. The resultant coating forms a strong, chemical bond to the metal surface that requires an unreasonable quantity of effort and equipment to remove. Such a coating provides protection for the metal substrate, and component-biologic system compatibility. Specifically, the present disclosure describes a new and novel process for adhering the suspension to the device during and after it has been deposited. The disclosed process provides improved placement accuracy (registration), improved adhesion, higher yields throughout the device assembly process, lower cost, negligible discoloration of a substrate, such as a sealplate, non-porous ceramic dots that do not form conductive shorts, and a visual indicator of the improved adhesion.

As used herein, the terms “implanted medical device” and “implantable medical device” refer to medical devices that are designed to be at least partially placed within a patient's body. Typically, such devices, or portions thereof, are placed within the patient's body for a period of time for which it could be beneficial to have a therapeutic agent present on the external surface of the device. For example, a medical device implanted in a patient's body for a few minutes to several hours, or more, constitutes an implantable medical device for the purposes of this disclosure.

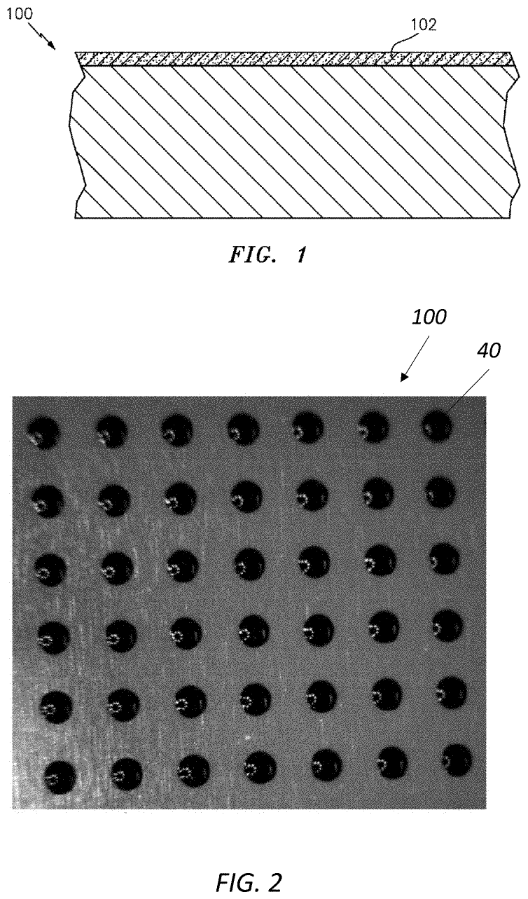

FIG. 1 illustrates a cross-sectional view of a substrate of metal (e.g., stainless steel) for forming ceramic dots 20 on a surface 102.

FIG. 2 illustrates exemplary ceramic dots 40 adhered to a stainless steel substrate after an ultrasonic bath. The ceramic dots 40 are applied to a substrate, such as metal 100, for coating purposes, according to some implementations, using jet dispensing or time and pressure needle dispensing. For the purposes of this illustration, the metal 100 can be made up of stainless steel. These processes are discussed in greater detail below. The ceramic dots 40, according to some implementations, are disposed on a substrate in one or more patterns.

Using a jet dispensing process, the material for the ceramic dots is applied in a uniform format. To accomplish the uniform application, the material is applied digitally. In some implementations, an apparatus can apply between two to five digital uniformly-spaced dots, simultaneously. The size of the ceramic dot 40 can also be uniform. For example, the final target height of the ceramic dot 40 can be modified (after curing/firing) by controlling the dispensed mass. In some implementations, the application of the ceramic dots 40 is fully automated. In this way, an X, Y, and Z position of the one or more ceramic dots on a substrate is automated and controlled.

Time and pressure needle dispensing includes placing a small dispense needle at the proper X, Y, and Z location over the substrate and dispense the material through the needle. The amount of material dispensed is metered by controlling time and pressure. Precision of the dispense can be achieved in this process. For example, after the dispense is completed, the machine is further programmed to dwell over the ceramic dot for a prescribed time to allow for a consistent ‘tail break’. This dwelling allows the material to naturally break/detach from the tip of the needle before the needle is indexed to the next location. The intention is to maximize the consistency of the amount of material placed at each location. If the needle is moved too soon, the amount of residual material on the tip of the needle varies more, leading to some locations receiving too little material, while the excess material on the needle tip is then added to the next position—resulting in too much being material dispensed.

Both the jet dispensing process and the time and pressure needle dispensing process provides, among other things, improved adhesion, higher yields throughout the device assembly process, lower cost, negligible discoloration of a substrate, such as a sealplate, non-porous ceramic dots that do not form conductive shorts, and a visual indicator of the improved adhesion.

The coated metal is then thoroughly dried in a relatively dust-free environment to assure the integrity of the final coating. This is to prevent subsequent process degradation. Drying times will vary based on thickness and composition of the dispensed coating. In some implementations, the alcohol is completely removed to minimize the risk of volatilizing the alcohol during heating causing dynamic delamination of the coating.

Once the ceramic dots are dispensed, the coated substrate (metal 100) can be inserted into a non-reactive chamber of an atmospheric furnace. The atmospheric composition, for some implementations, is made up of Dissociated Ammonia (75 atomic % Hydrogen, 25 atomic % Nitrogen). This atmospheric composition is designed to prevent non-preferential bonding of the glass/ceramic to the metal substrate. Further, such an atmospheric composition enables the benefit of preventing the non-coated regions of the substrate from becoming discolored.

In some implementations, a furnace capable of reaching at least a temperature of 1100-degrees Celsius is used. The peak firing temperatures can range between 800- to 1100-degrees Celsius. For some materials, the peak firing temperatures can range between 925- to 1025-degrees Celsius, or more specifically, between 955- to 990-degrees Celsius. For the purposes of this implementation, the peak firing temperature can be 965-degrees Celsius. The chamber, for some implementations, is substantially purged using a pure inert gas; for example, argon. Minimal traces of air, oxygen or nitrogen may also be present after the purge. The coated metallic substrate can be fired, inside the furnace, in the inert gas. In some implementations, the coated metallic substrate is fired for a total of twelve minutes, at a maximum temperature, for example 965-degrees Celsius, for up to three-minutes. It should be understood that the firing parameters should be fully dependent on the desired glass thermal characteristics; therefore, other temperatures and timings may be used.

The dot firing process provides a shaped ceramic component to proper specifications and good adhesion to the metallic substrate. The process reliably bonds the dot to the substrate by having a high firing temperature. The high firing temperature allows the ceramic glass grit to melt and vitrify while also creating diffusion between the ceramic and the SST. The SST can include SST Substrate (17-7PH). According to some implementations, the metal substrate is brought to room temperature after the dot firing process. About an hour after the dot firing process, the metal substrate is cooled, for example down to about a negative 73 degrees Celsius. The metal substrate can be held at the cooled down temperature for a period of time, for example up to 8 hours. According to some implementations, the amount of time the metal substrate is held at the cooled down temperature is based on the thickness of the metal substrate. This hardens the metal substrate. For some Implementations, the metal substrate is subsequently heated to about 510 degrees Celsius or more for a period of time, for example for about an hour. The subsequent heating can further harden the metal substrate. The benefit of the ceramic dots as described herein enable a metal substrate including the ceramic dots to be harden using cryo-processing and elevated temperatures, below the melting point of the ceramic dots.

As an example, an SST Substrate (17-7PH) brought back to room temperature after the dot firing process is at the Austenite Conditioning state referred to as Condition A 1750 which is close to the fully annealed state. When the SST Substrate (17-7PH) is cooled to a negative 73 degrees Celsius and held for multiple hours, for example up to 8 hours, the material is now at Condition R 100, which is substantially harder.

For example, the first firing parameters specific to firing glass-ceramic enamel blanket coatings on stainless steel for corrosion protection in aggressive chemistries, appliance surfaces, and artwork can vary from the second firing parameters specific to firing of low temperature co-fired ceramic (LTCC) dielectric materials for electronics.

Once the coated metallic substrate is fired, a post-firing acid clean is used in some implementations to remove the tarnish. Left untreated, the tarnish can damage or etch the ceramic dot material and diminish the adhesion. The coated metallic substrate can be exposed to inert/reducing/oxygen-scavenging atmospheres via subsequent firings. In some implementations, a post-fire electropolish is used to remove the tarnish. The fired coated metallic substrate can be slow-cooled to minimize stress between the ceramic dots and metal substrate.

The coated metal, according to some implementations, is dried in a relatively dust-free environment to assure the integrity of the final coating. This is to prevent subsequent process degradation. Drying times will vary based on thickness and composition of the dispensed coating. In some implementations, the alcohol is removed to minimize the risk of volatilizing the alcohol during heating causing dynamic delamination of the coating.

In conclusion, the ceramic dots, according to implementations described herein, have many over similar present implementations, including: achieving a direct chemical bond between a ceramic material and a metal substrate (for example, stainless steel alloy), which enables a strong bond between a ceramic dot and a substrate and alleviates delamination; and producing a chemically pristine substrate with high free energy, free bonds. Further, ceramic dots, according to implementations described herein, enable a higher hardness, increased dot strength, and improved crush force providing a more durable solution than other implementations. The process to manufacture ceramic dots according to implementations described herein enables multiple layers of the ceramic material coating, for example, by using jet dispensing or time and pressure needle dispensing techniques. It should be understood other alloys similar to 17-7PH/S17700 provide superior adhesion, including but not limited to PH13-8/S13800, 15-5PH/S15500, 15-7PH/S15700, 17-4PH/S17400, 633/S35000, 634/S35500, and A286/S66286.

According to some implementations, the processes described herein are used to form one or more of any of mechanical structures and electro-mechanical structures. Although described in connection with these implementations, those of skill in the art will recognize that changes can be made in form and detail without departing from the spirit and scope of the invention.

What is claimed is:

1. A method to fuse ceramic to a metallic substrate, the method comprising:
dispensing a ceramic material onto the metallic substrate; and
firing of the ceramic material to the metallic substrate at a temperature that promotes adhesion between the ceramic material and the metallic substrate.

2. The method of claim 1, wherein the metallic substrate is a stainless steel alloy.

3. The method of claim 2, wherein the peak firing temperature is between 800 degrees Celsius and 1100 degrees Celsius.

4. The method of claim 2, wherein the peak firing temperature is 965 degrees Celsius.

5. The method of claim 1, wherein the firing of the ceramic material is conducted in an inert atmosphere.

6. The method of claim 5, wherein the inert atmosphere includes Argon.

7. The method of claim 5, wherein the inert atmosphere includes Nitrogen.

8. The method of claim 1, wherein firing of the ceramic material is conducted in a reducing atmosphere.

9. The method of claim 8, wherein the reducing atmosphere includes ammonia.

10. The method of claim 8, wherein the reducing atmosphere includes an active reducing agent that causes a depletion of oxygen.

11. The method of claim 8, where the reducing atmosphere includes forming gas.

12. The method of claim 8, wherein the reducing atmosphere includes hydrogen.

13. The method of claim 8, wherein the reducing atmosphere includes a mixture of gases including hydrogen and one or more noble gases.

14. The method of claim 1, wherein the metallic substrate is a stainless steel substrate, and cooling the stainless steel substrate to a negative 73 degrees Celsius and heating the stainless steel substrate to 510 degrees Celsius.

15. The method of claim 1, wherein the ceramic material includes ceramic paste material.

16. The method of claim 1, wherein dispensing the ceramic material includes using a jet dispensing process that dispenses the ceramic material in a pattern of ceramic dots.

17. The method of claim 16, wherein the jet dispensing process enables customization of size and height of each of the ceramic dots.

18. The method of claim 1, wherein dispensing the ceramic material includes using a time and pressure needle dispensing process that dispense the ceramic material in a pattern of ceramic dots.

19. The method of claim 18, wherein the time and pressure needle dispensing process provides a metered amount of material dispensed by controlling time and pressure.

20. The method of claim 19, wherein the time and pressure needle dispensing process includes positioning a needle over each ceramic dot for a prescribed time period to allow for a consistent tail break.
